(19) United States
(12) Patent Application Publication
(10) Pub. No.: US 2009/0169763 A1
(43) Pub. Date: Jul. 2, 2009

(54) Process for the Production of Multi-Layer Coatings

(75) Inventors: Frank-Peter Tiegs, Wuppertal (DE); Michael Georgiadis, Wuppertal (GR); Marc Chilla, Sprockhoevel (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/304,594

(22) PCT Filed: Jun. 12, 2007
(86) PCT No.: PCT/US07/13969

§ 371 Date: Dec. 12, 2008

Related U.S. Application Data
(60) Provisional application No. 60/813,507, filed on Jun. 14, 2006.

(51) Int. Cl. B05B 5/04

(52) U.S. Cl. 427/484

(57) ABSTRACT

A process for the production of multi-layer coatings, comprising the successive steps:
1) applying a base coat layer in a total process film thickness in the range from 10 to 35 μm to a substrate provided with an EDC primer,
2) applying a clear coat layer onto the base coat layer,
3) jointly curing the base coat and clear coat layers,
   wherein the base coat layer is applied in a first layer of a modified water-borne base coat prepared by mixing an unmodified water-borne base coat having a black/white opacity of >25 μm with a pigmented admixture component and in a second layer of the unmodified water-borne base coat.

### FIELD OF THE INVENTION

The invention relates to a process for the production of multi-layer coatings.

### BACKGROUND OF THE INVENTION

Automotive coatings generally comprise a separately baked electrodeposition coating (EDC) primer, a separately baked primer surfacer layer (filler layer) applied thereto and a top coat applied thereto comprising a wet-on-wet applied color- and/or special effect-imparting base coat layer and a protective, gloss-imparting clear coat layer. The total primer surfacer plus base coat layer thickness is generally 30 to 60 μm, in case of metallic color shades more in the lower range of 30 to 45 μm.

Processes are known from WO 97/47401 and U.S. Pat. No. 5,976,343 for the production of decorative multi-layer coatings, which processes allow for the elimination of the application and separate baking of a primer surfacer layer which, of course, reduces coating material consumption and total layer thickness. In these processes, a multi-layer coating structure comprising a first, modified water-borne base coat, a second, unmodified water-borne base coat and a clear coat is applied by a wet-on-wet-on-wet process comprising the joint curing of these three coating layers that are applied to a baked EDC primer. In practice, these processes use two base coat layers that allow for markedly lower total layer thickness by approximately 15 to 25 μm, than that of a conventional primer surfacer and base coat. The modified water-borne base coat is produced in these processes from an unmodified water-borne base coat by mixing with an admixture component. The modified water-borne base coat replaces a conventional primer surfacer. WO 97/47401 recommends as an admixture component, the addition of polyisocyanate crosslinking agent, while U.S. Pat. No. 5,976,343 describes the addition of polyurethane resin.

A weakness of the processes known from WO 97/47401 and U.S. Pat. No. 5,976,343 is that it is not straightforwardly possible to produce multi-layer coatings in certain color shades (“problematic color shades”). Color shades which are problematic with regard to the production of multi-layer coatings without primer surfacer layer are those color shades with low hiding power. Such color shades are problematic because the substrate shows through the base coat layer produced from modified and unmodified water-borne base coat. In the case of substrates with a nonuniform color shade and/or due to fluctuations in film thickness (nonuniform distribution of film thickness on the substrate) of the base coat layer, nonuniformity of color shade is perceived. Bake-cured EDC primer coatings in particular are examples of problematic substrates which are nonuniform in color shade, because they often suffer from severe local discoloration as the result of localized differences in object temperature during bake curing.

The problem could be solved by applying the modified and/or the unmodified water-borne base coat in an overall higher, opaque layer thickness. However, this would be a backward technological step in the direction of high total film thickness, and the high, opaque film thickness would have to be built up in several applications, which would not be of assistance in ensuring a maximally economic coating process.

Raising the pigment content of the unmodified water-borne base coat is limited, on the one hand, by the critical pigment volume concentration, but is in general also not feasible with regard to the required technological properties of the finished coating.

### SUMMARY OF THE INVENTION

The invention is directed to a process for the production of multi-layer coatings, comprising the successive steps:
1) applying a base coat layer in a total process film thickness in the range from 10 to 35 μm to a substrate provided with an EDC primer,
2) applying a clear coat layer onto the base coat layer,
3) jointly curing the base coat and clear coat layers,

wherein the base coat layer is applied in a first layer and in a second layer; the first layer comprises a modified water-borne base coat produced by mixing an unmodified water-borne base coat with a pigmented admixture component and the second layer comprises the unmodified water-borne base coat,

wherein the unmodified water-borne base coat has a black/white opacity (black/white hiding power) of >25 μm,

wherein the admixture component is selected from the group consisting of admixture component I and admixture component II, wherein admixture component I comprises one or more binders A, having a ratio by weight of pigment content to resin solids content of 0.05:1 to 1.5:1 and being mixed into the unmodified water-borne base coat in a ratio by weight of 0.1 to 2.5 parts of binder(s) A:1 part of resin solids of the unmodified water-borne base coat; and wherein admixture component II comprises one or more polyisocyanates, having a ratio by weight of pigment content to resin solids content of 0.05:1 to 0.5:1 and being mixed into the unmodified water-borne base coat in a ratio by weight of 0.2 to 1 parts of polyisocyanate:1 part of resin solids of the unmodified water-borne base coat, and

wherein the pigment content of the admixture component is made such that the multi-layer coating achieved after step 3) achieves color shade consistency from in each case at least 80% (from in each case 80% and upwards, as far as it makes technical sense) of the individual process film thickness both of the layer applied from the modified water-borne base coat and of the layer applied from the unmodified water-borne base coat.

### DETAILED DESCRIPTION OF THE EMBODIMENTS

The film thicknesses indicated in the description and in the claims for coating layers refer in each case to dry film thicknesses. In the description and the claims the term “process film thickness” is used. The meaning of this term will be explained hereinbelow.

The term “black/white opacity” is used in the description and the claims. It refers to the dry coating thickness of a coating composition wherein the contrast between the black and white fields of a black and white chart coated with the coating composition is no longer visually discernible (mean coating thickness value determined on the basis of evaluation by 5 independent individuals). Following ISO 6504-3:2006 (E), method B, in order to determine this coating thickness, the coating composition of which the black/white opacity is to be investigated may be applied in a wedge shape onto a black and white chart and dried or hardened.

The term “pigment content” used in the description and the claims means the sum of all the pigments contained in a coating composition without fillers (extenders). The term “pigments” is used here as in DIN 55944 and covers, in addition to special effect pigments, inorganic white, colored and black pigments and organic colored and black pigments. At the same time, therefore, DIN 55944 distinguishes between pigments and fillers.

The description and the claims mention “one or more binders A”. This serves to distinguish between the binder(s) of the unmodified water-borne base coat and the binder(s) A of the admixture component I.

The phrase used in the description and the claims “color shade consistency of the multi-layer coating from in each case at least 80% of the individual process film thickness both of the layer applied from the modified water-borne base coat and of the layer applied from the unmodified water-borne base coat” means that the color difference delta E [delta E can be determined by goniospectrophotometric colorimetry and it equals the square root of (delta L*²+delta C*²+delta h*²); L*, C*, h*=lightness, chroma, hue] between multi-layer coatings to be compared and applied from modified water-borne base coat, unmodified water-borne base coat and clear coat is sufficiently small if the base coat layers applied both from the modified water-borne base coat and from the unmodified water-borne base coat have each been applied to 80% or more of the individual process film thickness. In the case of solid colors (single-tone color shades; generally independent of observation angle; pigment content without special effect pigments), delta E values of <0.4 determined at an illumination angle of 45° to the perpendicular and an observation angle of 45° relative to the specular reflection are sufficiently small and thus represent color shade consistency in the above sense. In the case of special effect color shades (dependent on observation angle; pigment content comprises at least one special effect-imparting pigment) delta E values are sufficiently small if the delta E values, when determined at an illumination angle of 45° to the perpendicular and at observation angles of 15, 25, 45, 75 and 110° relative to the specular reflection are in each case <2.

In goniospectrophotometric colorimetry the reflectance curves of visible light in the range from, for example, 380 to 800 nm of a coated surface are determined at one or more different observation angles. The reflectance curves may, for example, be determined at 5 observation angles, for example at 15, 25, 45, 75 and 110° relative to the specular reflection. The reflectance curves may be used as the basis for calculating the conventional CIEL*a*b* system calorimetric parameters L* (lightness), a* (red-green value), b* (yellow-blue value) and further also C* (chroma) and h* (hue) (c.f. DIN 6174) or these values are directly output from the measuring instrument. The reflectance curves may be determined using any conventional colorimeters known to the person skilled in the art, for example, the X-Rite MA 68 II instrument sold by the company X-Rite.

In the process according to the invention conventional substrates provided with an EDC primer, preferably a cathodic electrodeposition (CED) coating, are coated. In particular, the substrates are automotive bodies or automotive body parts. The production of substrates provided with an EDC primer is known to the person skilled in the art.

In step 1) of the process according to the invention, the substrates having an EDC primer are provided, with a base coat layer in a total process film thickness in the range from 10 to 35 μm. This base coat layer is applied in two layers, i.e., a first layer having an individual process film thickness in the range from, for example, 5 to 25 μm of a modified water-borne base coat produced by mixing an unmodified water-borne base coat with the admixture component is applied and a subsequent second layer in an individual process film thickness below black/white opacity, for example, in the range from 3 to 20 μm of the unmodified water-borne base coat then is applied. The total process film thickness of the base coat layer is dependent inter alia on color shade. Car manufacturers' requirements for base coat film thickness are expressed in the so-called process film thickness (average film thickness which is desired over the entire body in the automotive original coating process), which depends on the individual color shade, on technological properties to be achieved (e.g., stone chip resistance) and on an economic application of the relevant water-borne base coat, i.e., in as thin a film as possible. The total base coat process film thickness lies in the range from 10 to 35 μm and is the sum of, for example, 5 to 25 μm of the modified water-borne base coat plus, for example, 3 to 20 μm of the unmodified water-borne base coat. Such film thicknesses for base coats meet the requirements for coating the relevant substrates, for example, automotive bodies. In particular, this means that a specific value within this range from 10 to 35 μm represents the specific total process film thickness for a particular base coat, for example, a base coat of a particular color shade. Said specific total process film thickness is here composed of the sum of the specific individual process film thickness, lying within the range of, for example, 5 to 25 μm, of the corresponding modified water-borne base coat and the specific individual process film thickness, lying within the range of, for example, 3 to 20 μm of the corresponding unmodified water-borne base coat.

In the present invention a distinction is drawn between unmodified and modified water-borne base coats.

The unmodified water-borne base coats, from which the modified water-borne base coats may be produced by mixing with the admixture component I or II, are aqueous coating compositions having a ratio by weight of pigment content to resin solids content of, for example, 0.05:1 to 1:1. In addition to water, pigment(s), a resin solids content, which comprises binder(s), optionally, paste resin(s) and optionally, cross-linking agent(s), optionally, filler(s) and optionally, organic solvent(s), the unmodified water-borne base coats contain in general also conventional additive(s).

The unmodified water-borne base coats contain ionically and/or non-ionically stabilized binder systems. In case of ionic stabilization anionic stabilization is preferred. Anionic stabilization is preferably achieved by at least partially neutralized carboxyl groups in the binder, while non-ionic stabilization is preferably achieved by lateral or terminal polyethylene oxide units in the binder. The unmodified water-borne base coats may be physically drying or crosslinkable by formation of covalent bonds. The crosslinkable unmodified water-borne base coats forming covalent bonds may be self- or externally crosslinkable systems.

The unmodified water-borne base coats contain one or more conventional film-forming binders. They may optionally also contain crosslinking agents if the binders are not self-crosslinkable or physically drying. Examples of film-forming binders, which may be used, are conventional polyester, polyurethane, (meth)acrylic copolymer and/or hybrid resins derived from these classes of resin. Selection of the optionally contained crosslinking agents depends, in a manner familiar to the person skilled in the art, on the functionality of the binders, i.e., the crosslinking agents are selected in such a way that they exhibit a reactive functionality complementary to the functionality of the binders. Examples of such complementary functionalities between binder and crosslinking agent are: carboxyl/epoxy, hydroxyl/methylol ether and/or methylol (methylol ether and/or methylol preferably, as crosslinkable groups of aminoplast resins, in particular, melamine resins).

The term “polyurethane resin” as used in the present invention does not rule out that the polyurethane resin in question may also contain groups other than urethane groups in the polymer backbone, such as, in particular, ester groups and/or urea groups. Instead, the term “polyurethane resin” of course, also in particular, includes polyurethane resins which contain polyester polyol building blocks and/or urea groups, wherein the latter may, for example, be formed by the reaction of isocyanate groups with water and/or polyamine.

If the process according to the invention is performed with admixture component II, it is preferred to work with unmodified water-borne base coats which comprise a resin solids content comprising one or more hydroxyl-functional binders. Here, the hydroxyl value of the resin solids content of the unmodified water-borne base coat is, for example, in the range of from 10 to 150 mg KOH/g, the NCO/OH molar ratio in the modified water-borne base coat is, for example, 0.5:1 to 25:1. However, in the case of unmodified water-borne base coats with a low-hydroxyl or hydroxyl-free resin solids content, higher NCO/OH molar ratios may also arise in the corresponding modified water-borne base coats. For example, the NCO/OH molar ratios may even extend towards infinity. In such cases, the polyisocyanate in the modified water-borne base coat is consumed by reaction with other constituents, which are reactive in relation to isocyanate groups, for example, with water, hydroxyl-functional solvents and/or with functional groups of binders which are reactive with isocyanate and are different from hydroxyl groups.

The unmodified water-borne base coats contain conventional pigments, for example, special effect pigments and/or pigments selected from among white, colored and black pigments.

Examples of special effect pigments are conventional pigments which impart to a coating color flop and/or lightness flop dependent on the observation angle, such as, non-leafing metal pigments, for example, of aluminum, copper or other metals, interference pigments, such as, for example, metal oxide-coated metal pigments, for example, iron oxide-coated aluminum, coated mica, such as, for example, titanium dioxide-coated mica, graphite effect-imparting pigments, iron oxide in flake form, liquid crystal pigments, coated aluminum oxide pigments, coated silicon dioxide pigments.

Examples of white, colored and black pigments are the conventional inorganic or organic pigments known to the person skilled in the art, such as, for example, titanium dioxide, iron oxide pigments, carbon black, azo pigments, phthalocyanine pigments, quinacridone pigments, pyrrolopyrrole pigments, perylene pigments.

The unmodified water-borne base coats have a black/white opacity of >25 μm, i.e. they are water-borne base coats with problematic color shades with low hiding power, i.e. they comprise pigments which according to the kind and/or quantity thereof allow only for a low hiding power. Examples are in particular water-borne base coats with certain, in particular luminous blue, red, yellow or orange color shades which are especially distinguished by elevated brilliance and color purity. They may comprise solid color shades or special effect color shades, such as mica or metallic color shades.

The unmodified water-borne base coats generally comprise those which, despite their black/white opacity of >25 μm, are non-critical with regard to UV transmission. In other words, a base coat layer applied to the specific total process film thickness within the range of 10 to 35 μm only from such an unmodified water-borne base coat allows UV light to penetrate only in accordance with a UV transmission value of below 0.1% in the wavelength range from 280 to 380 nm, of below 0.5% in the wavelength range from 380 to 400 nm, and of below 1% in the wavelength range from 400 to 450 nm. Such unmodified water-borne base coats non-critical with regard to UV transmission are composed in such a manner, i.e. comprise a pigment content of such a type (qualitative and quantitative composition of the pigments forming the pigment content) and in such a quantity, that a base coat layer applied to the specific total process film thickness within the range of 10 to 35 μm only from the particular unmodified water-borne base coat allows UV light to penetrate only in accordance with a UV transmission value of below 0.1% in the wavelength range from 280 to 380 nm, of below 0.5% in the wavelength range from 380 to 400 nm, and of below 1% in the wavelength range from 400 to 450 nm. UV transmission may be measured by applying the relevant unmodified water-borne base coat in the relevant specific total process film thickness to a UV light-transmitting support, for example, a silica glass plate, and measuring the UV transmission in the corresponding wavelength range using a corresponding uncoated UV light-transmitting support as reference.

The unmodified water-borne base coats may also contain fillers, for example, in proportions of 0 to 30 wt. % relative to the resin solids content. The fillers do not constitute part of the pigment content of the unmodified water-borne base coats. Examples are barium sulfate, kaolin, talcum, silicon dioxide, layered silicates and any mixtures thereof.

The special effect pigments are generally initially introduced in the form of a conventional commercial aqueous or non-aqueous paste, optionally, combined with preferably water-dilutable organic solvents and additives and then mixed with aqueous binder. Pulverulent special-effect pigments may first be processed with preferably water-dilutable organic solvents and additives to yield a paste.

White, colored and black pigments and/or fillers may, for example, be ground in a proportion of the aqueous binder. Grinding may preferably also take place in a special aqueous paste resin. Grinding may be performed in conventional assemblies known to the person skilled in the art. The formulation is then completed with the remaining proportion of the aqueous binder or of the aqueous paste resin.

The unmodified water-borne base coats may contain conventional additives in conventional quantities, for example, of 0.1 to 5 wt. %, relative to the solids content thereof. Examples are antifoaming agents, wetting agents, adhesion promoters, catalysts, levelling agents, anticratering agents, thickeners and light stabilizers.

The water content of the unmodified water-borne base coats is, for example, 60 to 90 wt. %.

The unmodified water-borne base coats may contain conventional organic solvents, for example, in a proportion of preferably less than 20 wt. %, particularly preferably, less than 15 wt. %. Examples of such solvents are mono- or polyhydric alcohols, for example, propanol, butanol, hexanol; glycol ethers or esters, for example, diethylene glycol di-C1-C6-alkyl ether, dipropylene glycol di-C1-C6-alkyl ether, ethoxypropanol, ethylene glycol monobutyl ether; glycols, for example, ethylene glycol and/or propylene glycol, and the di- or trimers thereof; N-alkylpyrrolidone, such as, for example, N-methylpyrrolidone; ketones, such as, methyl ethyl ketone, acetone, cyclohexanone; aromatic or aliphatic hydrocarbons, for example, toluene, xylene or linear or branched aliphatic C6-C12 hydrocarbons.

The unmodified water-borne base coats have solids contents of, for example, 10 to 40 wt. %, preferably, of 15 to 30 wt. %.

In the first embodiment of the process according to the invention the modified water-borne base coat is produced from the unmodified water-borne base coat by mixing with the pigmented admixture component I in a ratio by weight of 0.1 to 2.5 parts of binder(s) A:1 part of resin solids of the unmodified water-borne base coat. In many cases it is possible to work with 0.1 to 1 parts of binder(s) A:1 part of resin solids of the unmodified water-borne base coat.

The addition of the pigmented admixture component I to the unmodified water-borne base coat imparts to the resultant modified water-borne base coat technological properties, such as, for example, stone chip resistance, which are important to the finished multi-layer coating. It is moreover ensured in this manner that color-consistent multi-layer coatings in the desired color shade (color shade specified by a coated standard) are obtained.

The admixture component I containing one or more binder(s) A and comprising a pigment content is a composition with a solids content of, for example, 20 to 100 wt. %, in general, of 30 to 60 wt. %. The volatile content is formed, in addition to possible volatile additives, by water and/or organic solvent. The solids content itself consists of the resin solids content plus the pigments forming the pigment content, optionally, plus fillers and optionally, plus nonvolatile additives. Fillers do not constitute part of the pigment content. The ratio by weight of pigment content to resin solids content is 0.05:1 to 1.5:1. The value of this ratio is the result of the fundamentally selected ratio of pigments to resin solids content and of the specific weight of the individual pigments forming the pigment content.

The resin solids content of the admixture component I comprises one or more binders A and, optionally, one or more resins which differ from the binder(s) A and are used as a separate pigment grinding medium or as a pigment grinding auxiliary (so-called grinding or paste resins) and, optionally, one or more crosslinking agents, for example, blocked polyisocyanates, aminoplast resins, such as, for example, melamine resins. In general, the resin solids content consists to an extent of 100 wt. % of the at least one binder A or, for example, of 70 to 99 wt. % of the at least one binder A plus 1 to 20 wt. % of at least one grinding resin differing from the binder(s) A plus 0 to 30 wt. % of at least one crosslinking agent, wherein the weight percentages add up to 100 wt. %.

The binder(s) A of the admixture component I may comprise the same binders as in the unmodified water-borne base coats and/or binders which differ therefrom.

The binder(s) A are conventional water-dilutable, preferably anionically stabilized binders, for example, corresponding polyester, polyurethane, (meth)acrylic copolymer and/or hybrid resins derived from these classes of resin. Polyester and in particular polyurethane resins are preferred.

Apart from the groups which ensure water dilutability, such as, in particular carboxyl groups, the binders A may comprise functional groups which may be involved in a crosslinking reaction which optionally proceeds during the subsequent thermal curing of the modified water-borne base coat; such crosslinking reactions are in particular addition and/or condensation reactions. The binders A may also be self-crosslinkable. Examples of binders' A functional groups are hydroxyl groups, blocked isocyanate groups and epoxy groups.

The admixture component I exhibits a ratio by weight of pigment content to resin solids content of 0.05:1 to 1.5:1. The sum of the solids contributions of the pigment content and the resin solids content is, for example, 15 to 100 wt. %, in general, 25 to 60 wt. % of the admixture component 1.

The pigment content of the admixture component I is made such that, with a given (particular) unmodified water-borne base coat, a given specific total process film thickness (and in each case also specific individual process film thicknesses for the modified and for the unmodified water-borne base coat), a given mixing ratio of admixture component I and unmodified water-borne base coat in the range from 0.1 to 2.5 parts by weight of binder(s) A:1 part by weight of resin solids content of the unmodified water-borne base coat and a given ratio by weight of pigment content to resin solids content of 0.05:1 to 1.5:1 of the admixture component I, the multi-layer coating produced from the modified water-borne base coat applied to at least 80% of the specific individual process film thickness, from the corresponding unmodified water-borne base coat applied to at least 80% of the specific individual process film thickness and the clear coat achieves color shade consistency. In particular, the pigment content of admixture component I is selected by type (qualitative and quantitative composition of the pigments forming the pigment content) and quantity accordingly.

The pigment contents of admixture components I in particular comprise hiding power imparting pigments. Suitable pigment contents are, for example, those with elevated proportions, for example, 80 or more wt. % of carbon black and/or titanium dioxide. For example, the individual proportion of carbon black or titanium dioxide may be selected with regard to color shade adjustment to the individual unmodified water-borne base coat in question. In particular, pigment contents with a proportion of 95 or more wt. % of titanium dioxide are in general suitable, especially corresponding white-colored pigment contents.

In general, the pigment(s) forming the pigment content of the admixture component I are ground. Grinding may be performed in conventional assemblies known to the person skilled in the art. The pigments may be ground in the presence of the at least one binder A. One or more grinding resins different from binder(s) A may here be added as grinding auxiliaries. Alternatively, it is however also possible to perform grinding in a separate grinding medium in the form of a grinding resin or a mixture of grinding resins different from binder(s) A.

Aluminum flake pigments are not ground, but instead generally initially introduced in the form of a conventional commercial non-aqueous paste, optionally, combined with preferably water-dilutable organic solvents and optionally, additives and then mixed with the binder(s) A. Pulverulent aluminum flake pigments may first be processed with preferably water-dilutable organic solvents and optionally additives to yield a paste.

Once the pigment preparations have been produced, they are made up into the finished admixture component I by being mixed with any remaining or missing constituents. In particular, if grinding was not performed in the presence of binder(s) A, the latter is/are mixed in to yield the finished admixture component 1.

The admixture component I may optionally contain one or more fillers, for example, 0 to below 5 wt. %. Examples of fillers usable in the admixture component I are barium sulfate, kaolin, talcum, silicon dioxide, and layered silicates.

The admixture component I generally comprises an aqueous composition; the admixture component I then contains, for example, 20 to 70 wt. % water.

Irrespective of whether it is an aqueous or non-aqueous composition, the admixture component I may contain one or more organic solvents, for example, in a total quantity of 5 to 70 wt. %. Examples of such solvents are mono- or polyhydric alcohols, for example, propanol, butanol, hexanol; glycol ethers or esters, for example, diethylene glycol C1-C6 dialkyl ethers, dipropylene glycol C1-C6 dialkyl ethers, ethoxypropanol, butylglycol; glycols, for example, ethylene glycol and/or propylene glycol, and the di- or trimers thereof; N-alkylpyrrolidones, for example N-methylpyrrolidone and ketones, for example, methyl ethyl ketone, acetone, cyclohexanone; aromatic or aliphatic hydrocarbons, for example, toluene, xylene, or linear or branched aliphatic C6-C12 hydrocarbons. The solvents are preferably water-dilutable.

In addition to the at least one binder A and the pigment(s) forming the pigment content and the in each case optional constituents fillers, water, organic solvent and grinding resin, the admixture component I may contain additives in proportions of in each case, for example, 0.1 to 4 wt. %, corresponding a total quantity of in general no more than 6 wt. %. Examples of additives are defoamers, anticratering agents, wetting agents, neutralizing agents, light stabilizers and rheology control agents.

In the second embodiment of the process according to the invention the modified water-borne base coat is produced from the unmodified water-borne base coat by mixing with the pigmented admixture component II in a ratio by weight of 0.2 to 1 parts, preferably of 0.2 to 0.8 parts of polyisocyanate:1 part of resin solids of the unmodified water-borne base coat.

The addition of the pigmented admixture component II to the unmodified water-borne base coat imparts to the resultant modified water-borne base coat technological properties, such as, for example, stone chip resistance, which are important to the finished multi-layer coating. It is moreover ensured in this manner that color-consistent multi-layer coatings in the desired color shade (color shade specified by a coated standard) are obtained.

The admixture component II containing one or more polyisocyanates and comprising a pigment content is a composition with a solids content of, for example, 30 to 100 wt. %, in general, of 40 to 95 wt. %, in particular, of 55 to 95 wt. %. The volatile content is formed, in addition to possible volatile additives, by water and/or organic solvent. The solids content itself consists of the resin solids content plus the pigments forming the pigment content, optionally, plus fillers and optionally, plus nonvolatile additives. Fillers do not constitute part of the pigment content. The ratio by weight of pigment content to resin solids content is 0.05:1 to 0.5:1. The value of this ratio is the result of the fundamentally selected ratio of pigments to resin solids content and of the specific weight of the individual pigments forming the pigment content.

The resin solids content of the admixture component II comprises one or more polyisocyanates and optionally, one or more resins used as a separate pigment grinding medium or as a pigment grinding auxiliary (“grinding” or “paste” resins). In general, the resin solids content consists to an extent of 100 wt. % of polyisocyanate(s) or, for example, of 85 to 99 wt. % of polyisocyanate(s) plus 1 to 15 wt. % of grinding resin(s), wherein the weight percentages add up to 100 wt. %.

The term “polyisocyanate(s)” used in connection with the admixture component II is not restricted to the meaning free polyisocyanate or free polyisocyanates, but instead also includes blocked polyisocyanate or blocked polyisocyanates. The polyisocyanate(s) contained in the admixture component II accordingly comprise one or more free polyisocyanates, one or more blocked polyisocyanates or a combination of one or more free polyisocyanates and one or more blocked polyisocyanates. Free polyisocyanates are preferred.

The polyisocyanates comprise di- and/or poly-isocyanates with aliphatically, cycloaliphatically, araliphatically and/or less preferably aromatically attached isocyanate groups.

The polyisocyanates are liquid at room temperature or are present as an organic solution; the polyisocyanates here exhibit at 23° C. a viscosity of in general 0.5 to 2000 mPa·s. The isocyanate content of the polyisocyanates present in the form of free or latent (blocked, thermally re-dissociable) isocyanate groups is in general in a range from 2 to 25 wt. %, preferably, from 5 to 25 wt. % (calculated as NCO).

Examples of diisocyanates are hexamethylene diisocyanate, tetramethylxylylene diisocyanate, isophorone diisocyanate, dicyclohexylmethane diisocyanate, and cyclohexane diisocyanate.

Examples of polyisocyanates are those which contain heteroatoms in the residue linking the isocyanate groups. Examples of these are polyisocyanates which contain carbodiimide groups, allophanate groups, isocyanurate groups, uretidione groups, urethane groups, acylated urea groups or biuret groups. The polyisocyanates preferably have an isocyanate functionality higher than 2, such as, for example, polyisocyanates of the uretidione or isocyanurate type produced by di- or trimerization of the above-mentioned diisocyanates. Further examples are polyisocyanates produced by reaction of the above-mentioned diisocyanates with water and containing biuret groups or polyisocyanates produced by reaction with polyols and containing urethane groups.

Of particular suitability are, for example, “coating polyisocyanates” based on hexamethylene diisocyanate, isophorone diisocyanate or dicyclohexylmethane diisocyanate. “Coating polyisocyanates” based on these diisocyanates means the per se known biuret, urethane, uretidione and/or isocyanurate group-containing derivatives of these diisocyanates.

As already mentioned above, the polyisocyanates may be used in blocked form, though this is not preferred. They may be blocked with conventional blocking agents that can be de-blocked under the action of heat, for example, with alcohols, oximes, amines and/or CH-acidic compounds.

The blocked or preferably free polyisocyanates may be used in the admixture component II as such or as a preparation containing water and/or organic solvent, wherein in the case of free polyisocyanate no water and no organic solvent with active hydrogen is used. It may be desirable, for example, for the polyisocyanates to be pre-diluted with a water-miscible organic solvent or solvent mixture. In this case, it is preferable to use solvents, which are inert relative to isocyanate groups, especially where the preferred free polyisocyanates are used. Examples are solvents which do not contain any active hydrogen, for example, ethers, such as, for example, diethylene glycol diethyl ether, dipropylene glycol dimethyl ether; glycol ether esters, such as, ethylene glycol monobutyl ether acetate, diethylene glycol monobutyl ether acetate, methoxypropyl acetate; and N-methylpyrrolidone.

Also suitable are hydrophilic polyisocyanates, which may be stabilized in the aqueous phase by a sufficient number of ionic groups and/or by terminal or lateral polyether chains. Hydrophilic polyisocyanates are sold as commercial products, for example, by Bayer under the name Bayhydur®.

The admixture component II exhibits a ratio by weight of pigment content to resin solids content of 0.05:1 to 0.5:1. The sum of the solids contributions of the pigment content and the resin solids content is, for example, 20 to 100 wt. %, in general, 30 to 95 wt. %, in particular, 45 to 95 wt. % of the admixture component II.

The pigment content of the admixture component II is made such that, with a given (particular) unmodified water-borne base coat, a given specific total process film thickness (and in each case also specific individual process film thicknesses for the modified and for the unmodified water-borne base coat), a given mixing ratio of admixture component II and unmodified water-borne base coat in the range from 0.2 to 1, preferably 0.2 to 0.8 parts by weight of polyisocyanate: 1 part by weight of resin solids content of the unmodified water-borne base coat and a given ratio by weight of pigment content to resin solids content of 0.05:1 to 0.5:1 of the admixture component II, the multi-layer coating produced from the modified water-borne base coat applied to at least 80% of the specific individual process film thickness, from the corresponding unmodified water-borne base coat applied to at least 80% of the specific individual process film thickness and the clear coat achieves color shade consistency. In particular, the pigment content of admixture component II is selected by type (qualitative and quantitative composition of the pigments forming the pigment content) and quantity accordingly.

As also in the case of admixture component I, the pigment content of admixture component II in particular comprises hiding power imparting pigments. In order to avoid repetition, reference is here made to the statements already made in connection with examples of suitable pigment contents of admixture component I.

In general, the pigment(s) forming the pigment content of the admixture component II are ground. Grinding may be performed in conventional assemblies known to the person skilled in the art. The pigments may be ground in the presence of the polyisocyanate, i.e., directly in the polyisocyanate as such or in the polyisocyanate as an organic and/or aqueous preparation. One or more grinding resins may here be added as grinding auxiliaries. Alternatively and in general also preferably, it is however also possible to perform grinding in a separate grinding medium in the form of a grinding resin or a mixture of grinding resins. In particular, when producing a preferred admixture component II containing free polyisocyanate, it is expedient to use a separate grinding medium.

Grinding resins suitable as a grinding auxiliary or separate grinding medium are those which are inert during grinding of the pigments, on mixing with the further constituents of the admixture component II, in particular on mixing with the free or blocked polyisocyanate and on further mixing with the unmodified water-borne base coat as well as in the finished modified water-borne base coat, for example, appropriate (meth)acrylic copolymer or polyurethane resins.

In particular, in the case of the production of a preferred admixture component II containing free polyisocyanate, grinding resins which are inert towards isocyanate groups are used as the grinding auxiliary or, in particular, as the grinding medium. Completely etherified amino resins, in particular, completely etherified melamine resins, such as, in particular, hexamethoxymethylmelamine, have surprisingly proved highly suitable for this purpose. Grinding here preferably proceeds in the completely etherified amino resin in the absence of the free polyisocyanate, for example, in a solids weight ratio of pigments to completely etherified amino resin of 0.1:1 to 3:1, said ratio being dependent inter alia on the kind of the pigment(s) used.

Particularly preferred admixture components II in the context of the preceding paragraph have a resin solids content consisting of a combination amounting to 100 wt. % of 1 to 15 wt. % of completely etherified amino resin and 85 to 99 wt. % of polyisocyanate, in particular free polyisocyanate.

Aluminum flake pigments are not ground, but instead generally initially introduced in the form of a conventional commercial non-aqueous paste, optionally, combined with preferably water-dilutable organic solvents and optionally, additives and then mixed with the polyisocyanate(s). Pulverulent aluminum flake pigments may first be processed with preferably water-dilutable organic solvents and optionally additives to yield a paste.

Once the pigment preparations have been produced, they are made up into the finished admixture component II by being mixed with any remaining or missing constituents. In particular, if grinding was not performed in the presence of the polyisocyanate, the latter is mixed in to yield the finished admixture component II.

When producing a preferred admixture component II containing free polyisocyanate, it is expedient not only to avoid the deliberate addition of water, but also to perform processing with the most extensive possible, preferably complete, exclusion of water and in general also with the most extensive possible, preferably complete, exclusion of other substances reactive towards isocyanate groups, such as, for example, alcohols. Apart from selecting appropriate raw materials, it is additionally possible to work with water-binding auxiliaries. For example, water scavengers, such as, orthoesters may be added during production and storage of the admixture component II containing free polyisocyanate.

The admixture component II may optionally contain one or more fillers, for example, 0 to 10 wt. %, relative to the solids content. Examples of fillers usable in the admixture component are barium sulfate, kaolin, talcum, silicon dioxide, layered silicates.

The admixture component II may, if it contains no free polyisocyanate, contain, for example, 20 to 70 wt. % water.

The admixture component II may contain one or more organic solvents, for example, in a total quantity of 5 to 70 wt. %. The solvents are preferably water-dilutable. In the case of the preferred admixture components II containing free polyisocyanate, the solvents are those which are inert towards isocyanate groups. Examples of suitable solvents are ethers, such as, for example, diethylene glycol diethyl ether, dipropylene glycol dimethyl ether; glycol ether esters, such as, ethylene glycol monobutyl ether acetate, diethylene glycol monobutyl ether acetate, methoxypropyl acetate; and N-methylpyrrolidone.

In addition to the at least one polyisocyanate and the pigment(s) forming the pigment content and in each case optional constituents fillers, water, organic solvent and grinding resin, the admixture component II may contain additives in proportions of in each case, for example, 0.1 to 2 wt. %, corresponding a total quantity of in general no more than 5 wt. %. Examples of additives are the same as those already mentioned for the admixture component I.

The unmodified water-borne base coat and the pigmented admixture component I or II are preferably mixed on the user's premises shortly or immediately before application of the modified water-borne base coat. In the case of industrial coating facilities, the unmodified water-borne base coats in each case of a different color shade are each conveyed in their own circulating line. In the process according to the invention, it is possible to work with only one or with two or more, for example, 2 to 5, in each case differently pigmented admixture components. It may be expedient to use more than one pigmented admixture component, each having different pigmentation, if the water-borne base coat is applied in a color shade program with two or more color shades and it is desired to make a particular adjustment between the particular color shades of the unmodified water-borne base coats and the color shade of the pigmented admixture component. For example, two or more color groups of unmodified water-borne base coats may be formed and assigned in each case to one of differently pigmented admixture components. For example, in the case of a light color shade of an unmodified water-borne base coat, the person skilled in the art will tend to select an admixture component with a light-colored pigment content.

The pigmented admixture components may be supplied to the user in ready-to-use form. They may, however, also be produced on the user's premises by mixing a pigment-free component with a pigmented component, for example, a pigment paste, before the resultant pigmented admixture component is then mixed with the unmodified water-borne base coat. Both stated mixing processes, namely mixing of the pigment-free component with the pigmented component and mixing of the pigmented admixture component with the unmodified water-borne base coat may proceed automatically using mixing technology conventional in industrial coating facilities, for example, by means of a static mixer, such as a Kenics mixer.

The pigmented admixture components, like the differently colored unmodified water-borne base coats, in each case may be conveyed in an own dedicated circulating line. When applying water-borne base coat in a color shade program of n color shades, it is therefore not necessary to provide for instance 2n circulating lines (in each case n circulating lines for the different colors of the unmodified water-borne base coats and for the different colors of the modified water-borne base coats), but rather just n circulating lines for the different colors of the unmodified water-borne base coats plus m, for example, 1 to 5, circulating lines for the pigmented admixture component(s).

In the event that the color shade program selected for coating the substrates also comprises unmodified water-borne base coats with unproblematic color shades having sufficient hiding power, the unmodified water-borne base coats with unproblematic color shades need not necessarily be mixed with the or one of the pigmented admixture components for the purpose of preparing the modified water-borne base coats, but it is instead possible in these cases also to work with an analogous pigment-free admixture component, for example, a pigment-free component as mentioned in the prepreceding paragraph. This approach, however, in general entails an additional circulating line for the pigment-free admixture component. In other words, if the color shade program comprises both unmodified water-borne base coats with problematic and also with unproblematic color shades, it is preferred for the modified water-borne base coats to be produced by mixing the unmodified water-borne base coats comprising a problematic color shade with a pigmented admixture component and by mixing the unmodified water-borne base coats comprising an unproblematic color shade with a pigment-free admixture component. For example, in this case, n circulating lines are required for the differently colored unmodified water-borne base coats with an unproblematic color shade and n′ circulating lines for the differently colored unmodified water-borne base coats with a problematic color shade plus one circulating line for the pigment-free admixture component plus m, for example 1 to 5, circulating lines for the pigmented component(s).

The process according to the invention may advantageously also be performed in such a manner that the pigmented admixture component is formed in situ by mixing a pigment-free and a pigmented component into the unmodified water-borne base coat in each case separately and so successively or, less preferably, simultaneously. The pigment-free component may, for example, be mixed into the unmodified water-borne base coat by means of a static mixer, before the pigmented component is then mixed into the resultant mixture, likewise by means of a further static mixer, or vice versa. In the case of a pigmented admixture component II, it is preferred to mix in the pigmented component first.

In the process according to the invention, the EDC-primed substrates are initially spray-coated with the modified water-borne base coat, preferably by electrostatically-assisted high-speed rotary atomization.

Then, preferably after a brief flash-off phase of, for example, 30 seconds to 5 minutes at an air temperature of 20 to 25° C., the corresponding unmodified water-borne base coat is spray-applied, preferably by pneumatic spray application.

This is preferably also followed by a brief flash-off phase of, for example, 30 seconds to 10 minutes at an air temperature of 20 to 100° C., after which the clear coat is applied in a dry film thickness of, for example, 20 to 60 μm.

All known clear coats are in principle suitable as the clear coat. Usable clear coats are both solvent-containing one-component (1 pack) or two-component (2 pack) clear coats, water-dilutable 1 pack or 2 pack clear coats, powder clear coats or aqueous powder clear coat slurries.

After an optional flash-off phase, the applied water-borne base coat layer consisting of modified and unmodified water-borne base coat and the clear coat layer are jointly cured, for example, by baking, for example, at 80 to 160° C. object temperature.

It is advantageous that repair coating of multi-layer coatings produced by the process according to the invention can be carried out with the unmodified water-borne base coat of the relevant problematic color shade without there being any deviation in color shade in the area of the repair. In other words, consistency in color shade of the kind already mentioned above is ensured, even if the repair coating is performed using only the corresponding unmodified water-borne base coat and not the modified water-borne base coat.

### EXAMPLES

### Example 1

### Production of a Pigmented Admixture Component

A pigmented admixture component of the following composition was produced in conventional manner (grinding of the pigments in a bead mill):

19.4 pbw (parts by weight) of resin solids (polyurethane binder, Bayhydrol® PT 241 from Bayer)

28.0 pbw of titanium dioxide (TiPure® R 706 from DuPont)

0.2 pbw of dimethylethanol amine

0.6 pbw of polyacrylic acid thickener

2.6 pbw of defoamer

39.6 pbw of deionized water

9.6 pbw of organic solvents (4.0 pbw of ethylene glycol monobutyl ether, 3.8 pbw of diethylene glycol monobutyl ether, 1.8 pbw of n-propanol).

### Example 2

### Production of a Pigment-Free Admixture Component

The same method was used as in Example 1, but without using titanium dioxide.

### Example 3

### Production of Water-Borne Base Coats

a) A yellow water-borne base coat of the following composition was produced:

18.0 pbw of resin solids (8.1 pbw of a polyester acrylate resin, 6.2 pbw of a polyurethane resin, 3.7 pbw of hexamethoxymethylmelamine)

0.4 pbw of Irgazin® Yellow 2RLT from Ciba

2.9 pbw of titanium dioxide (TiPure® R 706 from DuPont)

5.0 pbw of Irgacolor® Yellow 3GLM from Ciba

4.2 pbw of Heucodur Yellow 3R from Heubach

0.3 pbw of dimethylethanolamine

0.2 pbw of defoamer

0.6 pbw of polyacrylic acid thickener

1.0 pbw of polypropylene glycol 900

14.6 pbw of organic solvents (4.2 pbw of ethylene glycol monobutyl ether, 1.7 pbw of diethylene glycol monobutyl ether, 0.7 pbw of ethylene glycol monohexyl ether, 3.0 pbw of N-methylpyrrolidone, 3.5 pbw of n-butanol, 1.0 pbw of n-propanol, 0.5 pbw of Shellsol T)

52.8 pbw of deionized water.

The yellow unmodified water-borne base coat had a black/white opacity of 52 μm and a specific individual process film thickness of 15 μm.

b) A modified water-borne base coat was produced by mixing 100 pbw of the unmodified water-borne base coat from a) with 200 pbw of the admixture component from Example 1. The modified water-borne base coat had a specific individual process film thickness of 15 μm.

c) A water-borne coating composition was produced by mixing 100 pbw of the unmodified water-borne base coat from a) with such amount of the preparation from Example 2 to achieve the same ratio by weight of polyurethane binder (Bayhydrol® PT 241 from Bayer) to resin solids of the unmodified water-borne base coat from a) as in b).

### Examples 4a to 4c

### Production of Multi-Layer Coatings

4a) A Multi-layer coating 4a was obtained by the following procedure:

The modified water-borne base coat 3b was spray applied in a dry film thickness of 12 μm to automotive steel test panels 300 mm×600 mm in size and provided with a dark-grey EDC primer (lightness L*=8; colorimetrically determined at an illumination angle of 45° to the perpendicular and an observation angle of 45° relative to the specular reflection).

After flashing-off for 2 minutes at room temperature the unmodified water-borne base coat 3a was spray applied in a wedge-shaped gradient (wedge in longitudinal direction) to a dry film thickness range from 0 to 20 μm and allowed to flash-off for 5 minutes at 80° C.

The test panels provided in this way with a flashed off base coat layer were then spray coated with a commercial two-component polyurethane clear coat in a dry film thickness of 40 μm and after flashing-off for 5 minutes at 20° C. baked for 20 minutes at 140° C. object temperature.

4b): A Multi-layer coating 4b was obtained by repeating Example 4a with the difference that the water-borne coating composition 3c was used instead of water-borne base coat 3b.

4c): A further multi-layer coating 4c was produced without making use of modified water-borne base coat 3b or water-borne coating composition 3c. To this end the unmodified water-borne base coat 3a was spray applied in a dry film thickness of 60 μm to an automotive steel test panel provided with the dark-grey EDC primer. To this end 3 spray passes in each case followed by a forced drying step of 5 minutes at 70° C. were performed. Thereafter the two-component polyurethane clear coat was spray applied in a dry film thickness of 40 μm and after flashing-off for 5 minutes at 20° C. baked for 20 minutes at 140° C. object temperature.

The multi-layer coatings 4a and 4b so obtained were in each case calorimetrically assessed at an illumination angle of 45° to the perpendicular and an observation angle of 45° relative to the specular reflection in accordance with the method known from U.S. Pat. No. 5,991,042 using the X-Rite MA 68 II instrument sold by the company X-Rite. Multi-layer coating 4c was calorimetrically measured using the same equipment.

Table 1 shows the delta E values calculated from the calorimetric data as a function of the dry film thickness of the unmodified water-borne base coat 3a [delta E₄ₐ=square root of (L*_{4c}²−L*₄ₐ²+c*_{4c}²−c*₄ₐ²+h*_{4c}²−h*₄ₐ²); delta E_{4b}=square root of (L*_{4c}²−L*_{4b}²+c*_{4c}²−c*_{4b}²+h*_{4c}²−h*_{4b}²)].

TABLE 1

| | Dry film thickness of 3a (μm) | | | | | | | | | | |
|---|---|---|---|---|---|---|---|---|---|---|---|
| | 5 | 7 | 9 | 10 | 11 | 12 | 13 | 14 | 15 | 17 | 19 |
| delta E₄ₐ | 2.30 | 1.52 | 0.78 | 0.61 | 0.51 | 0.36 | 0.32 | 0.30 | 0.29 | 0.26 | 0.20 |
| delta E_{4b} | 5.21 | 4.94 | 4.66 | 4.50 | 4.35 | 4.21 | 4.05 | 3.89 | 3.74 | 3.45 | 3.20 |

1. A process for the production of multi-layer coatings, comprising the successive steps:
1) applying a base coat layer in a total process film thickness in the range from 10 to 35 μm to a substrate provided with an EDC primer,
2) applying a clear coat layer onto the base coat layer,
3) jointly curing the base coat and clear coat layers,
wherein the base coat layer is applied in a first layer and in a second layer; the first layer comprises a modified water-borne base coat produced by mixing an unmodified water-borne base coat with a pigmented admixture component and the second layer comprises the unmodified water-borne base coat,
wherein the unmodified water-borne base coat has a black/white opacity of >25 μm, wherein the admixture component is selected from the group consisting of admixture component I and admixture component II, wherein admixture component I comprises one or more binders A, having a ratio by weight of pigment content to resin solids content of 0.05:1 to 1.5:1 and being mixed into the unmodified water-borne base coat in a ratio by weight of 0.1 to 2.5 parts of binder(s) A:1 part of resin solids of the unmodified water-borne base coat; and wherein admixture component II comprises one or more polyisocyanates, having a ratio by weight of pigment content to resin solids content of 0.05:1 to 0.5:1 and being mixed into the unmodified water-borne base coat in a ratio by weight of 0.2 to 1 parts of polyisocyanate:1 part of resin solids of the unmodified water-borne base coat, and
wherein the pigment content of the admixture component is made such that the multi-layer coating achieved after step 3) achieves color shade consistency from in each case at least 80% of the individual process film thickness both of the layer applied from the modified water-borne base coat and of the layer applied from the unmodified water-borne base coat.

2. The process of claim 1, wherein the substrate is selected from the group consisting of automotive bodies and automotive body parts.

3. The process of claim 1, wherein the individual process film thickness of the first base coat layer of the modified water-borne base coat is in the range from 5 to 25 μm and the individual process film thickness of the second base coat layer of the unmodified water-borne base coat is in the range from 3 to 20 μm.

4. The process of claim 1, wherein the unmodified water-borne base coat comprises such a water-borne base coat, that a base coat layer applied only thereof and to the specific total process film thickness within the range of 10 to 35 μm allows UV light to penetrate only in accordance with a UV transmission value of below 0.1% in the wavelength range from 280 to 380 nm, of below 0.5% in the wavelength range from 380 to 400 nm, and of below 1% in the wavelength range from 400 to 450 nm.

5. The process of claim 1 comprising either
(i) pigmented admixture component I wherein said pigmented admixture component I is mixed with the unmodified water-borne base coat in a ratio by weight of 0.1 to 1 parts of binder(s) A:1 part of resin solids of the unmodified water-borne base coat; or
(ii) pigmented admixture component II, wherein said pigmented admixture component II is mixed with the unmodified water-borne base coat in a ratio by weight of 0.2 to 0.8 parts of polyisocyanate:1 part of resin solids of the unmodified water-borne base coat.

6. The process of claim 1, wherein the pigment content of the admixture component comprises 80 or more wt. % of carbon black, titanium dioxide or a combination of carbon black and titanium dioxide.

7. The process of claim 6, wherein the pigment content of the admixture component comprises at least 95 wt. % of titanium dioxide.

8. The process of claim 1, wherein the pigmented admixture component is prepared by mixing a pigment-free component with a pigmented component.

9. The process of claim 8, wherein the pigmented admixture component is formed in situ by separately mixing the pigment-free component and the pigmented component into the unmodified water-borne base coat.

10. The process of claim 1, wherein the modified water-borne base coat is applied by electrostatically-assisted high-speed rotary atomization and the unmodified water-borne base coat is pneumatically spray-applied.

11. A substrate coated with a multi-layer coating produced according to the process of claim 1.
